(19) United States
(12) Patent Application Publication
(10) Pub. No.: US 2017/0373934 A1
(43) Pub. Date: Dec. 28, 2017

(54) METHOD OF CONFIGURING LOW-POWER WIRELESS NETWORK AND SYSTEM USING THE SAME

(71) Applicant: Electronics and Telecommunications Research Institute, Daejeon (KR)

(72) Inventors: Wan-Ki PARK, Daejeon (KR); Chang-Sic CHOI, Daejeon (KR); Il-Woo LEE, Daejeon (KR); Jin-Doo JEONG, Sejong-si (KR); Jin-Soo HAN, Daejeon (KR); Se-Wan HEO, Daejeon (KR)

(73) Assignee: Electronics and Telecommunications Research Institute, Daejeon (KR)

(21) Appl. No.: 15/629,246

(22) Filed: Jun. 21, 2017

(30) Foreign Application Priority Data
Jun. 22, 2016 (KR) 10-2016-0077982

(51) Int. Cl. H04L 12/24; H04M 1/725; H04W 8/00; H04L 29/08; H04W 84/18

(52) U.S. Cl. CPC H04L 41/0806; H04W 8/005; H04L 67/12; H04M 1/72527; H04W 84/18

(57) ABSTRACT

A system for configuring low-power wireless network is disclosed. The system includes at least one wireless device configured to be used in a low-power wireless network and be assigned to a new network identifier and a new device identifier; a network coordinator configured to manage the low-power wireless network using the new network identifier and the new device identifier; and a mobile terminal configured to search for the wireless device and assign the new network identifier and the new device identifier to the searched wireless device and transmit the new network identifier and the new device identifier to the network coordinator.

### CROSS REFERENCE TO RELATED APPLICATION

This application claims the benefit of Korean Patent Application No. 10-2016-0077982, filed Jun.22, 2016, which is hereby incorporated by reference in its entirety into this application.

### BACKGROUND OF THE INVENTION

### 1. Technical Field

The present invention relates to a technology for configuring low-power wireless network using a mobile terminal, and more particularly, to a technology for changing a network setting value and a security setting of a wireless device configuring the low-power wireless network using a mobile terminal.

### 2. Description of the Related Art

A low-power wireless network (wireless sensor network) technology is possible to configure a network easily with relatively low cost when a managing target has a lot of liquidity and a new hardware installation is difficult so that it is being used in various fields. However, it is necessary to configure a new network considering an object to be a managing target and a surrounding wireless network environment. Also, a method for programming a network value (a network identifier, a device identifier, etc.) and a security setting value of each device which is needed for configuring the network for each device individually and a method for configuring according to separate basis are required. Furthermore, a method for managing an object to be a managing target with a network module is required.

### SUMMARY OF THE INVENTION

The present invention provides a technology for easily managing a network setting value to a wireless device which is assigned by directly identifying and figuring an object to be a managing target by a user using a mobile terminal. Furthermore, the present invention, if necessary, provides a technology for directly identifying an obtained value from the sensing object by a coordinator of a wireless network in which a mobile terminal is installed.

According to an aspect of the invention, there is provided a method of configuring low-power wireless network including a system for configuring low-power wireless network, which includes at least one wireless device configured to be used in the low-power wireless network and be assigned to a new network identifier and a new device identifier; a network coordinator configured to manage the low-power wireless network using the new network identifier and the new device identifier; and a mobile terminal configured to search for the wireless device by configuring a wireless network for setting separate new network including the wireless device itself as a coordinator of the wireless network and, assign the new network identifier and the new device identifier to the searched wireless device and transmit the new network identifier and the new device identifier set through a wireless LAN (WiFi) network to the network coordinator after the network setting and configuring.

According to another aspect of the invention, there is provided a method of configuring low-power wireless network using a mobile terminal, which includes initializing a wireless device requiring a new network setting; searching for a wireless device around a mobile terminal; transmitting a new network identifier and a new device identifier to be applied to a searched wireless device to the searched wireless device; and transmitting the new network identifier and the new device identifier to a network coordinator.

According to a still another aspect of the invention, there is provided a mobile terminal, which includes a processer; and a memory, wherein the memory stores commands for performing a method of configuring low-power wireless network, wherein, when the commands are executed by the processer, the commands are configured to search for a wireless device around a mobile terminal while the mobile terminal becomes a wireless network coordinator for a wireless device requiring a setting, transmit a new network identifier and a new device identifier to be applied to a searched wireless device to the searched wireless device, and transmit the new network identifier and the new device identifier to a network coordinator, and, if necessary, the mobile terminal itself becomes a wireless network coordinator for a wireless device so that a user may directly identify a status value of a sensing object assigned to each wireless device on the spot using the mobile terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram of a system for configuring low-power wireless network according to an embodiment of the present invention;

FIGS. 2A to 2C are diagrams of explaining a configuring low-power wireless network according to an embodiment of the present invention;

FIG. 3 is a block diagram of a wireless device according to an embodiment of the present invention;

FIG. 4 is a diagram showing a wired connection between a mobile terminal and a network coordinator according to an embodiment of the present invention;

FIG. 5 is a flowchart of a method of configuring low-power wireless network according to an embodiment of the present invention; and

FIG. 6 is a block diagram of a mobile terminal performing a method of configuring low-power wireless network according to an embodiment of the present invention.

### DESCRIPTION OF THE PREFERRED EMBODIMENTS

The present invention is susceptible of various modifications and has various exemplary embodiments, so specific embodiments will be described in drawings and are be described in sufficient detail. However, the present invention is not to be taken in a limiting sense for specific embodiments, it should be understood that the present invention includes all modifications, equivalents, and alternatives falling within the spirit and scope of the present invention. In the following description of the present invention, detailed descriptions of known functions and configurations which are deemed to make the gist of the present invention obscure will be omitted. Furthermore, the singular terms used in the specification and the claims should be generally interpreted to mean “one or more” unless otherwise stated.

Hereinafter, preferred embodiments of the present invention are described in detail below with reference to the accompanying drawings, wherein the same or corresponding components are denoted by the same reference numerals, and redundant description thereof will be omitted.

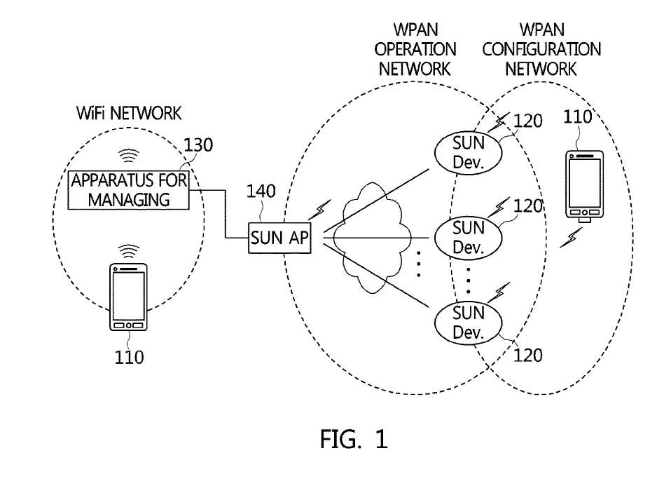

FIG. 1 is a diagram of a system for configuring low-power wireless network according to an embodiment of the present invention.

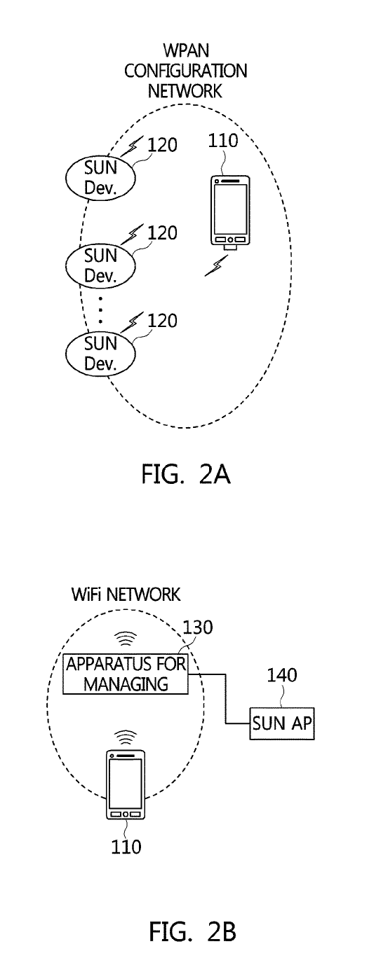

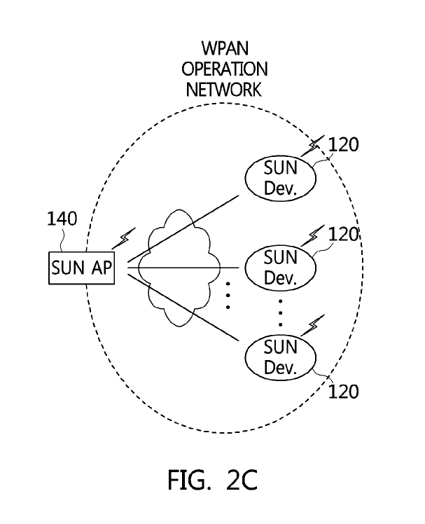

Referring to FIG. 1, the system for configuring low-power wireless network includes a mobile terminal 110, a wireless device 120, an apparatus 130 for managing a wireless device, and a network coordinator 140. The mobile terminal 110 configures a new network identifier and a new device identifier to the wireless device. The wireless device 120 connects through a randomly connection with a managing target controlled by the apparatus 130 for managing a wireless device so that sensing information can be identified and control information for an operation can be transmitted. The apparatus 130 for managing a wireless device controls the operation of the managing target. The network coordinator 140 manages a low-power wireless network configured with the wireless device 120. Hereinafter, the configuring low-power wireless network is described in detail with reference to the FIGS. 2A to 2C.

FIGS. 2A to 2C are diagrams of explaining a configuring low-power wireless network according to an embodiment of the present invention.

Referring to FIG. 2A, a configuring network configured with the mobile terminal 110 and a wireless device is shown. A wireless device to configure a new network has an already known value through an initialization process using a certain method. The mobile terminal 110 becomes a known wireless network coordinator and searches for a wireless device existing around which is used in a low-power wireless network with a new wireless network setting value. In this case, the mobile terminal 110 identifies the searched wireless device using each device identifier. The mobile terminal 110 transmits a new network identifier, a new device identifier and a security setting value for security to be applied to each searched wireless device to the searched device. Here, the new network identifier is mutually same with the wireless device configuring a same low-power wireless network, but the new device identifier is mutually different from the wireless device configuring a same low-power wireless network. The wireless device 120 stores and reboots the new network identifier, the new device identifier and the security setting value transmitted from the mobile terminal 110, applies the new network identifier, the new device identifier and the security setting value, and prepares to operate in the low-power wireless network.

Referring to FIG. 2B, a network registering a new identifier configured with the mobile terminal 110 storing the wireless network setting value which is newly set, the apparatus 130 for managing a wireless device, and the network coordinator 140 to a network coordinator is shown. The mobile terminal 110 transmits the new network identifier and the new device identifier applied to the wireless device to the apparatus 130 for managing a wireless device through a wireless LAN (WiFi). The apparatus 130 for managing a wireless device registers the new network identifier, the new device identifier and the security setting value received from the mobile terminal 110 to the network coordinator. In this case, the apparatus 130 for managing a wireless device may identify a managing target to be controlled using device identification information of the wireless device connected to the managing target. Furthermore, according to an embodiment, the mobile terminal 110 may directly register the new network identifier, the new device identifier and the security setting value to the network coordinator. Furthermore, according to an embodiment, the apparatus for managing a wireless device and the network coordinator may be physically implemented as a single apparatus.

Referring to FIG. 2C, a network configured with the wireless device 120 and the network coordinator 140 is shown. The network coordinator 140 configures a network according to the registered new network identifier by using wireless devices waiting to operate in the low-power wireless network applying the new network identifier, the new device identifier and the security setting value, and manages a network by identifying each wireless device using the new device identifier applied to each wireless device.

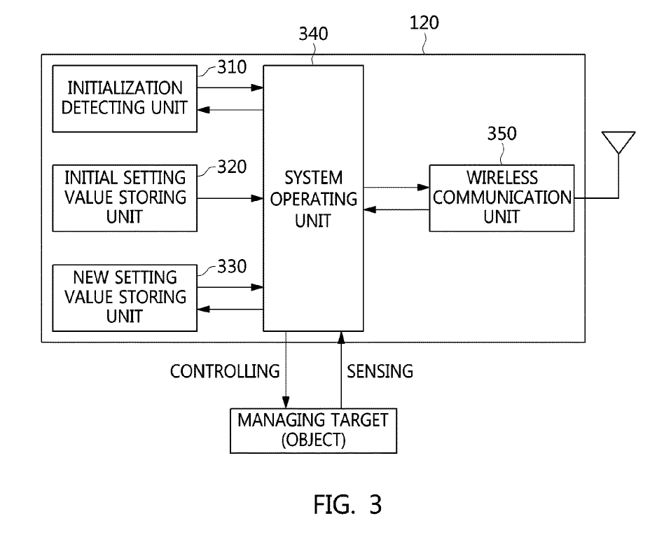

FIG. 3 is a block diagram of a wireless device according to an embodiment of the present invention.

Referring to FIG. 3, the wireless device 120 includes an initialization detecting unit 310, an initial setting value storing unit 320, a new setting value storing unit 330, a system operating unit 340 and a wireless communication unit 350.

The initialization detecting unit 310 detects whether a network setting initialization command such as a network identifier and a device identifier is input from a user. In the following description, the network setting value means that the network setting value and the security setting value are included.

The initial setting value storing unit 320 stores an initial network setting value such as a network identifier, a device identifier and a security setting value which are initially determined at a manufacturing stage of the wireless device.

The new setting value storing unit 330 stores a new network setting value such as a new network identifier, a new device identifier determined by the mobile terminal.

The system operating unit 340 controls an operation of the wireless device. Particularly, the system operating unit 340 stores in the new network setting value storing unit 330 when a new network setting value is received. The system operating unit 340 applies a new network setting value by rebooting the wireless device when a new network setting value is received. The system operating unit 340 initializes the applied new network setting value and applies an initial network setting value stored in the initial setting value storing unit 320, when the network setting initialization command input is detected from the initialization detecting unit 310. The system operating unit 340 transmits a control command for the managing target received from the apparatus for managing a wireless device to a managing target object. The system operating unit 340 transmits the information received from the managing target object to the apparatus for managing a wireless device.

The wireless communication unit 350 connects the wireless device to the wireless network environment using the wireless communication method.

Furthermore, the wireless device may include an input unit (not shown) receiving the network setting initialization command from a user.

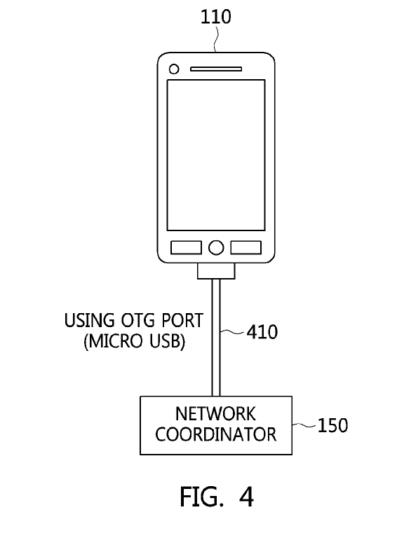

FIG. 4 is a diagram showing a wired connection for connecting a simple mobile terminal (which cannot provide a wireless coordinator function) to a wireless network module which can provide the wireless coordinator function, for a mobile terminal to provide the wireless coordinator function for providing a new wireless network setting function according to an embodiment of the present invention.

Referring to FIG. 4, a mobile terminal 110 and a network coordinator 150 are connected through a wired cable 410. The wired cable 410 connects the network coordinator 150 and the mobile terminal 110 through an OTG port (a micro USB) of the mobile terminal 110. In this case, the mobile terminal 110 transmits the new network identifier, the new device identifier and the security setting value to be applied to the wireless device to the network coordinator 150. The OTG port (the micro USB) is merely an example so that a communication port of the mobile terminal 110 capable of wired data communication may be used.

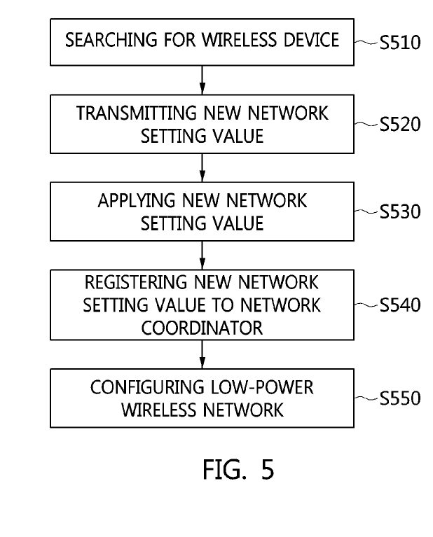

FIG. 5 is a flowchart of a method of configuring low-power wireless network according to an embodiment of the present invention.

Referring to FIG. 5, at step S510, the mobile terminal searches for a wireless device to configure the mobile terminal.

At step S520, the mobile terminal transmits a new network setting value including such as the new network identifier, the new device identifier and the security setting value for configuring the low-power wireless network to the searched wireless device.

At step S530, the wireless device stores a new network setting value including such as the new network identifier and the new device identifier receiving from the mobile terminal, and applies a new network setting value including such as the new network identifier and the new device identifier for configuring the low-power wireless network.

At step S540, the mobile terminal transmits the new network setting value including the new network identifier and the new device identifier applied to the wireless device to the network coordinator (SUN AP) 140 through a WiFi network using a wireless managing apparatus. The network coordinator 140 registers a new network setting value including a new network identifier and a new device identifier receiving from the mobile terminal for configuring a low-power wireless network.

At step S550, the network coordinator 140 configures and manages a low-power wireless network configured with a wireless device to which the new network identifier is applied. In this case, the network coordinator 140 identifies each wireless device using the new device identifier applied to each wireless device.

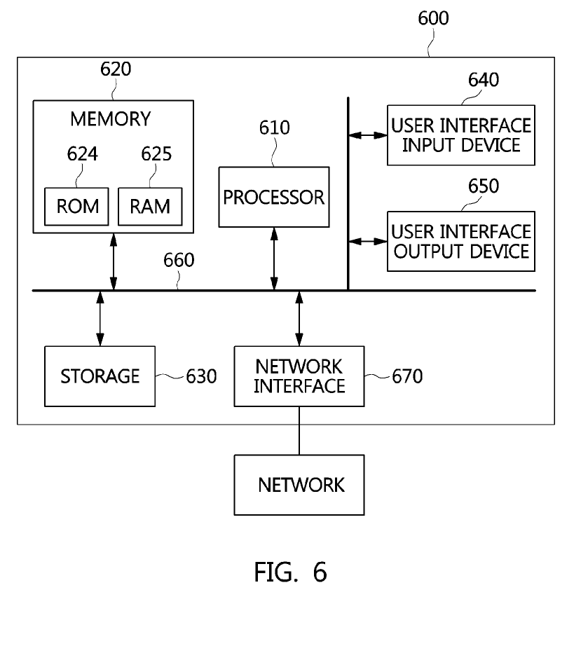

The embodiments of the present invention may be implemented in the mobile terminal and may be implemented as a mobile terminal readable recording medium. As shown in FIG. 6, a mobile terminal 600 may include at least one or more elements among one or more processor 610, a memory 620, a storage 630, a user interface input device 640 and a user interface output device 650, and they may communicate with each other through a bus 660. Furthermore, the mobile terminal 600 may also include a network interface 670 for connecting to a network. The processor 610 may be a CPU or a semiconductor device executing a processing command stored in the memory 620 and/or the storage 630. The memory 620 and the storage 630 may include various types of volatile/nonvolatile storage media. For example, the memory may include a ROM 624 and a RAM 625.

Accordingly, the embodiments of the present invention may be implemented as a method using a mobile terminal or may be implemented as a nonvolatile recording medium. The recording medium may store commands which are executable by the mobile terminal. When the commands are executed by the processor, the commands may perform the method according to at least one embodiment of the present invention.

The hardware devices described above may be configured to operate as one or more software modules in order to perform the operation of the present invention, and vice versa.

The embodiments of the present invention have been described above. Those skilled in the art of the present invention will understand that the invention may be embodied in various modifications without departing from the essential characteristics of the present invention. Therefore, the disclosed embodiments shall be considered in a described perspective rather than a limited perspective. The scope of the present invention is determined only according to the attached claims rather than the described above, and all differences within the scope of equivalents thereof should be construed as being included in the present invention.

According to an embodiment of the present invention, a network setting of an object to be a managing target can be easily managed using a mobile terminal, and if necessary, a user can identify a status value of a sensor and can control a sensor object in the field where the sensor object is installed.

What is claimed is:

1. A system for configuring low-power wireless network, comprising:
at least one wireless device configured to be used in a low-power wireless network and be assigned to a new network identifier and a new device identifier;
a network coordinator configured to manage the low-power wireless network using the new network identifier and the new device identifier; and
a mobile terminal configured to search for the wireless device and assign the new network identifier and the new device identifier to the searched wireless device and transmit the new network identifier and the new device identifier to the network coordinator.

2. The system of claim 1, wherein the wireless device applies the new network identifier and the new device identifier assigned by the mobile terminal, and is managed by the new network coordinator after registering the new network identifier and the new device identifier to the new network coordinator.

3. The system of claim 1, wherein the network coordinator registers the new network identifier and the new device identifier received from the mobile terminal, and identifies each wireless device using the new device identifier.

4. The system of claim 1, wherein the mobile terminal transmits the new network identifier and the new device identifier to the network coordinator using a wired cable connected through a micro USB port.

5. The system of claim 1, wherein the wireless device comprises:
a new setting value storing unit for storing the new network identifier and the new device identifier received from the mobile terminal; and
a system operating unit for applying the new network identifier and the new device identifier stored in the new setting value storing unit to the wireless device.

6. The system of claim 5, wherein the wireless device further comprises:
an initial setting value storing unit for storing an initial network identifier and an initial device identifier determined at a manufacturing stage of the wireless device; and
an initialization detecting unit for detecting a network setting initialization command, and
wherein the system operating unit applies the initial network identifier and the initial device identifier stored in the initial setting value storing unit to the wireless device when the initialization detecting unit detects the network setting initialization command.

7. A method of configuring low-power wireless network using a mobile terminal, comprising:
searching for a wireless device around a mobile terminal;
transmitting a new network identifier and a new device identifier to be applied to a searched wireless device to the searched wireless device; and
transmitting the new network identifier and the new device identifier to a network coordinator.

8. The method of claim 7, wherein the transmitting the new network identifier and the new device identifier to a network coordinator transmits the new network identifier and the new device identifier to the network coordinator using a wired cable connected through a micro USB port.

9. A mobile terminal, comprising:
a processer; and
a memory,
wherein the memory stores commands for performing a method of configuring low-power wireless network,
wherein, when the commands are executed by the processer, the commands are configured to
search for a wireless device around a mobile terminal,
transmit a new network identifier and a new device identifier to be applied to a searched wireless device to the searched wireless device, and
transmit the new network identifier and the new device identifier to a network coordinator.

10. The mobile terminal of claim 9, wherein the commands transmit the new network identifier and the new device identifier to the network coordinator using a wired cable connected through a micro USB port.
